(19) United States
(12) Patent Application Publication
(10) Pub. No.: US 2014/0279365 A1
(43) Pub. Date: Sep. 18, 2014

(54) Method and Apparatus for Real-Time Benchmarking

(71) Applicant: INTEGRAL DEVELOPMENT INC., PALO ALTO, CA (US)

(72) Inventors: Vikas Srivastava, Palo Alto, CA (US); Patrick Barkhordarian, Los Altos Hills, CA (US); Michelle Yip Chen, San Mateo, CA (US)

(21) Appl. No.: 14/214,075

(22) Filed: Mar. 14, 2014

Related U.S. Application Data
(60) Provisional application No. 61/790,657, filed on Mar. 15, 2013.

(51) Int. Cl. G06Q 40/04

(52) U.S. Cl. CPC G06Q 40/04
USPC 705/37

(57) ABSTRACT

Methods and apparatuses for generating continuous benchmark values are provided. In one example, a method for generating continuous benchmark values includes: (i) obtaining a first plurality of rates associated with a currency pair from a plurality of providers during a first period of time; (ii) generating a first benchmark value associated with the currency pair for a first point in time based on the first plurality of rates; (iii) obtaining a second plurality of rates associated with the currency pair from the plurality of providers during a second period of time; and (iv) generating a second benchmark value associated with the currency pair for a second point in time based on the second plurality of rates.

### CROSS-REFERENCE TO RELATED APPLICATIONS

This application claims priority to U.S. provisional patent application No. 61/790,657 having the title Method, System, and Apparatus for Real-Time Benchmarking. This application is also related to, and incorporates herein in their entirety, the following provisional patent applications, all filed Mar. 15, 2013: U.S. provisional patent application No. 61/791,369 entitled “Method, System, and Apparatus for Generating and Facilitating the Application of Trading Algorithms Across a Multi-Source Liquidity Market” and U.S. provisional patent application No. 61/794,585 entitled “Method, System, and Apparatus for Generating and Operating a Swaps Trading Platform.”

This application is also related to U.S. patent application Ser. No. 12/984,651, filed Jan. 5, 2011, titled “Systems and Methods for Conducting Financial Transactions,” which is a continuation of U.S. patent application Ser. No. 10/911,076, filed Aug. 3, 2004, titled “Systems and Methods of Conducting Financial Transactions,” which is a continuation-in-part of U.S. patent application Ser. No. 09/703,198 filed Oct. 31, 2000, titled “System and Method for Conducting Web-Based Financial Transactions in Capital Markets,” the entirety of all of which is hereby incorporated by reference. This application also incorporates in its entirety herein by reference each of: (i) U.S. provisional patent application Ser. No. 60/139,113 filed Jun. 14, 1999, titled “System and Method for an XML Vocabulary for Capital Markets”; (ii) U.S. provisional patent application Ser. No. 60/162,873 filed Nov. 1, 1999, titled “Method and Apparatus for Web-Based Management of Financial Risk and Pricing and Trading of Financial Products”; (iii) U.S. patent application Ser. No. 09/593,324 filed Jun. 13, 2000, titled “System and Method for Conducting Web-Based Financial Transactions in Capital Markets,” now U.S. Pat. No. 6,347,307; (iv) U.S. provisional patent application Ser. No. 61/035,655 filed Mar. 11, 2008, titled “System and Method for Conducting Web-Based Financial Transactions in Capital Markets”; and (v) U.S. patent application Ser. No. 12/402,370 filed Mar. 11, 2009, titled “System and Method for Conducting Web-Based Financial Transactions in Capital Markets.” Each of the foregoing is assigned to the assignee of the present invention.

### FIELD

The instant disclosure relates generally to foreign exchange (“FX” or “Forex”) trading and, more specifically, to a method and apparatus for generating continuous benchmark values.

### BACKGROUND

Benchmarking, within the context of foreign exchange market trading, refers to the establishment of a baseline rate for the trade of a given currency pair. That is to say, a benchmark value for a given currency pair is designed to reflect a “fair” rate at which that currency pair may be purchased or sold, taking into account a variety of market factors. In this manner, a benchmark value is a “virtual value” that does not necessarily reflect the rate at which a given currency pair is actually being traded at, but rather, the rate (or range) at which a given currency pair should be fairly traded at in light of relevant market forces. As known in the art, foreign exchange rates reflect a price per unit. As such, an offer rate for buying EUR/USD could be, for example, 1.365 for sizes between 0.1 mm-1 mm, however, the price of buying 0.1 mm EUR/USD will be different from the price of buying ten times more. In addition, as used herein, the term “rate” generally refers to a two-sided rate, i.e., both a bid rate (rate to sell) and an offer rate (rate to buy). While several different processes may be employed to establish a benchmark value for a given currency pair, a properly calculated benchmark value may provide parties executing trades on a forex market with valuable additional insight.

Conventional systems that supply benchmark values only do so sparingly. For example, typical systems that supply benchmark values do so only a few times each day (e.g., hourly). Because forex markets often exhibit rampant fluctuation, these periodic benchmark values may quickly become inaccurate or obsolete. Moreover, conventional benchmark value generating systems do not account for size in generating the benchmark values. As such, current systems do not provide a complete view of the market. Further still, such existing systems make it exceedingly difficult for parties to perform accurate transactional cost analysis (TCA). Accordingly, a new method and apparatus aimed at alleviating the drawbacks of conventional technology are desired.

### SUMMARY

The instant disclosure describes a method and apparatus for generating continuous, real-time benchmark values for one or more currency pairs. To this end, in one example, a method for generating benchmark values is provided. The method includes (i) obtaining a first plurality of rates associated with a currency pair from a plurality of providers during a first period of time; (ii) generating a first benchmark value associated with the currency pair for a first point in time based on the first plurality of rates; (iii) obtaining a second plurality of rates associated with the currency pair from the plurality of providers during a second period of time; and (iv) generating a second benchmark value associated with the currency pair for a second point in time based on the second plurality of rates. In one example, the second period of time may be within one second of the first period of time.

In one example, the method may include selecting a portion of the first plurality of rates associated with the currency pair. In this example, the generation of the first benchmark value may be based on the selected portion of the first plurality of rates. In another example, the selection of the portion of the first plurality of rates associated with the currency pair is based on profile information associated with each of the plurality of providers. In yet another example, the profile information associated with each of the plurality of providers may include one or more of the following types of information: (i) provider type information identifying each particular provider as one of a bank, an electronic communications network (ECN), or a non-bank and (ii) historical performance information describing a past performance of each particular provider in terms of at least one of: volume traded, acceptance ratio, industry ranking, or other criteria known to those having ordinary skill in the art.

In one example of the method, the generation of the first benchmark value may involve one or more determinations. Specifically, the generation may entail determining an average rate of the first plurality of rates for the first period of time. Such a determination may involve sampling currency pair rates at a point in time (or over a period of time) before the “first point in time” and at a different point in time (or over a different period of time) after the “first point in time,” and averaging the results. In another example, the generation of the first benchmark value may entail determining a median rate of the first plurality of rates for the first period of time. As with the previous example, this may involve sampling rates at times before and after the “first point in time.” In still another example, the generation of the first benchmark value may entail determining an optimal (i.e., “top of the book,” or “best”) rate for one or more currency pairs for the first period of time. In yet another example, the generation of the first benchmark value may entail taking a “snapshot” at the “point in time” and averaging out the mid rates from the plurality of providers.

In another example of the method, the generation of the first benchmark value associated with the currency pair may involve one or more separate, or additional, determinations. In one example, the generation of the first benchmark value may entail determining: (i) price at depth; (ii) a first volume-weighted average price (VWAP) for the first plurality of rates; (iii) a second VWAP for the first plurality of rates, wherein in the second VWAP is based on a approximated predefined rejection rate (e.g., 25%); (iv) an average of (a) the first VWAP and (b) the price at depth; (v) a time-weighted average price (TWAP) using a weighted average price over a moving predetermined window of time (e.g., 10 seconds); and/or (vi) a best bid and a best offer at each size for the first plurality of rates based upon block trade rates obtained from one or more of the plurality of providers.

In one example, the method may additionally include filtering at least one of the first and second plurality of rates prior to generating at least one of the first and second benchmark values. Several techniques may be employed to perform the filtering, or “data-cleansing.” For instance, in one example, the filtering may include removing (i.e., “throwing out”) the highest and lowest rates for a given currency pair before performing any of the determinations that may be used to generate the first and/or second benchmark values.

In another example, the method may include generating display data representing: (i) the first benchmark value for display on a display device; (ii) the second benchmark value for display on a display device; (iii) both the first and second benchmark values for simultaneous display on a display device; and/or (iv) a change in benchmark values over a period of time. Of course, those having ordinary skill will recognize that in certain instances the benchmark value(s) need not be displayed at all. Rather, in these exemplary embodiments, the benchmark values may be stored in analog and/or digital form to be used as desired. In still another example, the method may include generating a transactional cost analysis (TCA) on a per-user basis based on at least one of the first and second benchmark values.

### BRIEF DESCRIPTION OF THE FIGURES

Reference will now be made to the accompanying figures and flow diagrams, which are not necessarily drawn to scale, and wherein:

FIG. 1 is a block diagram illustrating one example of a computing device suitable for use in generating continuous, real-time benchmark values in accordance with one example of the disclosed technology.

FIG. 2 is a block diagram illustrating an apparatus for generating continuous, real-time benchmark values in accordance with one example the disclosed technology.

FIG. 3 is a flowchart illustrating a method for generating benchmark values associated with a currency pair in accordance with one example the disclosed technology.

FIG. 4 is a flowchart illustrating a method for generating benchmark values associated with a currency pair in accordance with another example the disclosed technology.

FIG. 5 is a flowchart illustrating a method for generating benchmark values associated with a currency pair in accordance with yet another example the disclosed technology.

FIG. 6 is a flowchart illustrating a method for generating benchmark values associated with a currency pair in accordance with still another example the disclosed technology.

FIG. 7 is a flowchart illustrating a method for generating benchmark values associated with a currency pair in accordance with another example the disclosed technology.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It must also be noted that, as used in the specification and the appended claims, the singular forms “a,” “an” and “the” include plural referents unless the context clearly dictates otherwise.

Ranges may be expressed herein as from “about,” “substantially,” or “approximately” one particular value and/or to “about,” “substantially,” or “approximately” another particular value. When such a range is expressed, another embodiment includes from the one particular value and/or to the other particular value.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Various embodiments of the disclosed technology provide a method, system, and apparatus for generating continuous, real-time benchmark values. In one example embodiment, a method for generating continuous, real-time benchmark values is provided. The method may include (i) obtaining a first plurality of rates associated with a currency pair from a plurality of providers during a first period of time; (ii) generating a first benchmark value associated with the currency pair for a first point in time based on the first plurality of rates; (iii) obtaining a second plurality of rates associated with the currency pair from the plurality of providers during a second period of time; and (iv) generating a second benchmark value associated with the currency pair for a second point in time based on the second plurality of rates. In one example, the second period of time may be within one second of the first period of time.

In another example embodiment, a computer program product embodied in a non-transitory computer-readable medium comprising an algorithm adapted to effectuate a method is provided. The method may include (i) obtaining a first plurality of rates associated with a currency pair from a plurality of providers during a first period of time; (ii) generating a first benchmark value associated with the currency pair for a first point in time based on the first plurality of rates; (iii) obtaining a second plurality of rates associated with the currency pair from the plurality of providers during a second period of time; and (iv) generating a second benchmark value associated with the currency pair for a second point in time based on the second plurality of rates. In one example, the second period of time may be within one second of the first period of time.

Referring now to the Figures, in which like reference numerals represent like parts, various embodiments of the computing devices and methods will be disclosed in detail. FIG. 1 is a block diagram illustrating one example of a computing device 100 suitable for use in generating continuous, real-time benchmark values.

FIG. 1 illustrates a representative computing device 100 that may be used to implement the teachings of the instant disclosure. The device 100 may be used to implement, for example, one or more components of the computing device shown in FIG. 2, as described in greater detail below. Regardless, the device 100 includes one or more processors 102 operatively connected to a storage component 104. The storage component 104, in turn, includes stored executable instructions 116 and data 118. In an embodiment, the processor(s) 102 may include one or more of a microprocessor, microcontroller, digital signal processor, co-processor or the like or combinations thereof capable of executing the stored instructions 116 and operating upon the stored data 118. Likewise, the storage component 104 may include one or more devices such as volatile or nonvolatile memory including but not limited to random access memory (RAM) or read only memory (ROM). Further still, the storage component 104 may be embodied in a variety of forms, such as a hard drive, optical disc drive, floppy disc drive, flash memory, etc. Processor and storage arrangements of the types illustrated in FIG. 1 are well known to those having ordinary skill in the art. In one embodiment, the processing techniques described herein are implemented as a combination of executable instructions and data within the storage component 104.

As shown, the computing device 100 may include one or more user input devices 106, a display 108, a peripheral interface 110, other output devices 112, and a network interface 114 in communication with the processor(s) 102. The user input device 106 may include any mechanism for providing user input to the processor(s) 102. For example, the user input device 106 may include a keyboard, a mouse, a touch screen, microphone and suitable voice recognition application, or any other means whereby a user of the device 100 may provide input data to the processor(s) 102. The display 108 may include any conventional display mechanism such as a cathode ray tube (CRT), flat panel display, or any other display mechanism known to those having ordinary skill in the art. In an embodiment, the display 108, in conjunction with suitable stored instructions 116, may be used to implement a graphical user interface. Implementation of a graphical user interface in this manner is well known to those having ordinary skill in the art. The peripheral interface 110 may include the hardware, firmware and/or software necessary for communication with various peripheral devices, such as media drives (e.g., magnetic disk or optical disk drives), other processing devices, or any other input source used in connection with the instant techniques. Likewise, the other output device(s) 112 may optionally include similar media drive mechanisms, other processing devices, or other output destinations capable of providing information to a user of the device 100, such as speakers, LEDs, tactile outputs, etc. Finally, the network interface 114 may include hardware, firmware, and/or software that allows the processor(s) 102 to communicate with other devices via wired or wireless networks, whether local or wide area, private or public, as known in the art. For example, such networks may include the World Wide Web or Internet, or private enterprise networks, as known in the art.

While the computing device 100 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 100 may include a greater or lesser number of components than those illustrated. Once again, those of ordinary skill in the art will appreciate the wide number of variations that may be used is this manner. Further still, although a single computing device 100 is illustrated in FIG. 1, it is understood that a combination of such computing devices may be configured to operate in conjunction (for example, using known networking techniques) to implement the teachings of the instant disclosure.

FIG. 2 is a block diagram illustrating an apparatus 200 for generating continuous, real-time benchmark values. In one example, the apparatus 200 may be implemented by the computing device 100 described above. However, those having ordinary skill in the art will appreciate that other computing systems, beyond the computing system 100 of FIG. 1, may also be suitably employed without deviating from the present disclosure. Apparatus 200 includes a rate obtaining module 202 and a benchmark value generating module 204 operatively connected to the rate obtaining module 202. In one or more embodiments, apparatus 200 may additionally include (i) a selection and filtering module 206 operatively connected to the rate obtaining module 202 and the benchmark value generating module 204, (ii) a transactional cost analysis module 226 operatively connected to the benchmark value generating module 204, and/or (iii) a provider profile database 242 operatively connected to the selection and filtering module 206. As will be appreciated by those having ordinary skill in the art, any or all of the modules 202, 204, 206, and 226 may be implemented as hardware, software, or a combination of hardware and software, including those hardware and/or software embodiments discussed above with regard to FIG. 1. In addition, the provider profile database 242 may be implemented as data and/or instructions stored in memory in one or more known database schemas.

Apparatus 200 is operatively connected (e.g., communicatively coupled) to one or more providers 208-212 over one or more wireless or wired networks 214 (e.g., the internet) using techniques well known in the art. As used herein, providers 208-212 may include, but are not limited to: banks, electronic communication networks (ECNs), and non-banks (e.g., one or more hedge funds). In one embodiment, an auditor 250 is operatively connected to the benchmark value generating module 204 of the apparatus 200 for reasons that will become apparent in view of the following discussion.

In operation, apparatus 200 is configured to obtain a multitude of rates associated with one or more currency pairs from the one or more providers 208-212 via the network(s) 214. As used herein, “obtaining” may include fetching/retrieving or receiving.

Apparatus 200 may obtain one or more rates 230 for a given currency pair from provider 1 208 over a time period denoted X. Similarly, apparatus 200 may obtain one or more rates 234 for the given currency pair from provider 2 210 over the same time period (also denoted X). Finally, apparatus 200 may obtain one or more rates 238 for the given currency pair from provider N 212 over the same time period (also denoted X). The plurality of rates concerning a given currency pair from the one or more providers 208-212 obtained during the time period X are represented by reference numeral 216 of FIG. 2.

The rate obtaining module 202 of the apparatus 200 is configured to obtain the plurality of rates associated with the currency pair over time period X 216 from one or more of the providers 208-212. In one example, the time period X is one second (1 s). However, those having ordinary skill in the art will appreciate that the actual time period may be longer or shorter than one second without deviating from the teachings of the instant disclosure.

After the plurality of rates associated with the currency pair over time period X 216 have been obtained by the rate obtaining module 202, the benchmark value generating module 204 is configured to obtain the rate information 216 (i.e., the plurality of rates associated with the currency pair over time period X) from the rate obtaining module 202 for further processing. Specifically, the benchmark value generating module 204 is configured to generate a benchmark value associated with the currency pair for a first point in time 222 based on the rate information 216.

In one example, the first point in time is situated at the midpoint of the first period of time. Thus, in an example where the first period of time is one second, the first point in time is situated approximately five hundred milliseconds (500 ms) after the start of the first period of time and, consequently, 500 ms before the end of the first period of time. Of course, those having ordinary skill in the art will recognize that the first point in time need not be situated at the midpoint of the first period of time. For example, in one embodiment, the first point in time may occur at or around the end of the first period of time. In still another embodiment, the first period of time and the first point in time may be the same. Stated another way, in this embodiment, a “snapshot” of one or more rates associated with a currency pair is taken at a given point in time, rather than over a period of time.

The benchmark value generating module 204 is configured to generate the benchmark value associated with the currency pair for the first point in time 222 based on the rate information 216 in a variety of manners. For example, in one embodiment, the benchmark value associated with the currency pair for the first point in time 222 is generated by determining an average rate for a given currency pair over the period of time. Thus, continuing with this example, the benchmark value generating module 204 may obtain the rate information 216 reflecting the rate for the given currency pair from one or more of the providers 208-212 over the relevant period of time (e.g., time period X). The benchmark value generating module 204 may then sum all of the rates for that currency pair and divide the summed amount by the total number of rates for that currency pair under consideration.

In another embodiment, the benchmark value associated with the currency pair for the first point in time 222 is generated by determining a median rate for a given currency pair over the period of time (e.g., time period X). Thus, continuing with this example, the benchmark value generating module 204 may obtain the rate information 216 reflecting the rate for the given currency pair from one or more of the providers 208-212 over the period of time. The benchmark value generating module 204 may then identify the median rate for that currency pair from amongst all of the available rates for that currency pair over the period of time.

In yet another embodiment, the benchmark value associated with the currency pair for the first point in time 222 is generated by determining an optimal rate (i.e., “top of the book” or “best rate,” as those terms are understood by those having ordinary skill in the art) for a given currency pair over the period of time (e.g., time period X). Thus, continuing with this example, the benchmark value generating module 204 may obtain the rate information 216 reflecting the rate for the given currency pair from one or more of the providers 208-212 over the period of time. The benchmark value generating module 204 may then identify the optimal rate for that currency pair from amongst all of the available rates for that currency pair over the period of time.

Other embodiments of the instant disclosure allow for the generation of a benchmark value for a currency pair that takes into account size. As known in the art, “size” refers to the volume being traded in relation to a given currency pair. In one exemplary embodiment, the benchmark value associated with the currency pair for the first point in time 222 is generated by determining price at depth for a given currency pair over the period of time. As known in the art, “price at depth” means the rate for a trade at a given size.

In another embodiment, the benchmark value associated with the currency pair for the first point in time 222 is generated by determining a first volume-weighted average price (VWAP) for a given currency pair over the period of time. As known in the art, “volume weighted average price” means executing a trade by dividing the trade into smaller subtrades and calculating the volume weighted average price for the trade by using the subtrades. Thus, in one example, a user may wish to buy 500 mm EUR/USD, however, the best rates available are for smaller sizes (as is often the case in foreign exchange markets). Accordingly, the user may wish to buy a smaller size X million from the provider with the best rates, then buy Y million from the provider with the second best rates, and so on, until the user reaches the total desired fill of 500 mm.

In still another embodiment, the benchmark value associated with the currency pair for the first point in time 222 is generated by determining a second VWAP for a given currency pair over the period of time. In this embodiment, the second VWAP is based on an approximated predefined rejection rate. As known in the art, an approximated predefined rejection rate reflects an assumed rate at which prices are rejected (i.e., trades are not consummated in accordance with the price at issue). To clarify further, in addition to VWAP, in one example, the system described herein may take into consideration a historical rejection rate associated with one or more of the providers 208-212 reflecting how often each provider has reneged on/retracted a published rate from that provider. For example, in one embodiment, if a best rate is from provider 1 208, but historically, provider 1 208 has retracted its published offer rate 25% of the time, then provider 1 208 may not included in the list of providers that are considered in generating the benchmark value(s) 222/224.

In yet another embodiment, the benchmark value associated with the currency pair for the first point in time 222 is generated by determining an average of the first VWAP and the price at depth for a given currency pair over the period of time.

In yet another embodiment, the benchmark value associated with the currency pair for the first point in time 222 is generated by determining a time-weighted average price (TWAP) for a given currency pair using a weighted average price over a moving period of time. The “moving period of time” may be the same or different from the “period of time” referenced above. For example, in this embodiment, currency pair rates that are closer to the point in time may be given a greater weight than currency pair rates further away from the point in time.

While the forgoing discussion concerned ways in which a first benchmark value 222 may be generated by the benchmark value generating module 204, the aforementioned techniques may equally be applied to generate a second benchmark value 224 in line with the following discussion.

Apparatus 200 may also obtain one or more rates 232 for a given currency pair from provider 1 208 over a time period denoted Y. In one example, time period Y exists chronologically after time period X discussed above. In one example, time period Y may begin (and end, in an example where time period Y is a point in time) immediately after time period X. Nonetheless, apparatus 200 may obtain one or more rates 236 for the given currency pair from provider 2 210 over the same time period (also denoted Y). Finally, apparatus 200 may obtain one or more rates 240 for the given currency pair from provider N 212 over the same time period (also denoted Y). The plurality of rates concerning a given currency pair from the one or more providers 208-212 obtained during the time period Y are represented by reference numeral 218 of FIG. 2.

The rate obtaining module 202 of the apparatus 200 is configured to obtain the plurality of rates associated with the currency pair over time period Y 218 from one or more of the providers 208-212. In one example, the time period Y is one second (1 s). However, those having ordinary skill in the art will appreciate that the actual time period may be longer or shorter than one second without deviating from the teachings of the instant disclosure.

After the plurality of rates associated with the currency pair over time period Y 218 have been obtained by the rate obtaining module 202, the benchmark value generating module 204 is configured to obtain the rate information 218 (i.e., the plurality of rates associated with the currency pair over time period Y) from the rate obtaining module 202 for further processing. Specifically, the benchmark value generating module 204 is configured to generate a benchmark value associated with the currency pair for a second point in time 224 based on the rate information 218.

In one example, the second point in time is situated at the midpoint of the second period of time. Thus, in an example where the second period of time is one second, the second point in time is situated approximately five hundred milliseconds (500 ms) after the start of the second period of time and, consequently, 500 ms before the end of the second period of time. Of course, those having ordinary skill in the art will recognize that the second point in time need not be situated at the midpoint of the second period of time. For example, in one embodiment, the second point in time may occur at or around the end of the second period of time. In still another embodiment, the second period of time and the second point in time may be the same. Stated another way, in this embodiment, a “snapshot” of one or more rates associated with a currency pair is taken at a given point in time, rather than over a period of time.

The benchmark value generating module 204 is configured to generate the benchmark value associated with the currency pair for the second point in time 224 based on the rate information 218 using any of the techniques disclosed above with regard to generating a benchmark value associated with the currency pair for the first point in time 222. In this manner, apparatus 200 is configured to generate a benchmark value for a given currency pair at a first point in time (e.g., an initial benchmark value for the currency pair) and then generate one or more subsequent benchmark values (e.g., “updated” benchmark values) for the same currency pair on a substantially continuous basis to reflect, in near real-time, the fluctuating rate associated with that currency pair.

In one embodiment, the benchmark value generating module 204 is further configured to generate display data representing the first benchmark value 222, the second benchmark value 224, and/or both the first and second benchmark values 222, 224 simultaneously. For example, in this embodiment, the benchmark value generating module 204 is configured to generate display data, such as, but not limited to, pixel data for display on a display device such as the display devices discussed above with regard to FIG. 1. In one example, the generated display data may be transmitted via one or more wired or wireless networks for display on one or more display devices that are remote from the apparatus 200. In another embodiment, the generated display data may be transmitted to one or more display devices that are part of the apparatus 200 (display device(s) are not shown in FIG. 2 for purposes of simplicity).

As noted above, in one embodiment, apparatus 200 includes a selection and filtering module 206 operatively connected to the rate obtaining module 202, the benchmark generating module 204, and a provider profile database 242. In this embodiment, the selection and filtering module 206 is configured to perform selection and/or filtering operations on the rate information 216/218. For example, in one embodiment, the selection and filtering module 206 is configured to obtain rate information 216 (note that this process may apply equally to rate information 218). The selection and filtering module 206 may then select a portion of the rate information 216 (i.e., information identifying certain rates associated with the currency pair, but not others). The selected portion of the rate information 248 may then be provided to the benchmark value generating module 204. In this embodiment, the benchmark value generating module 204 may be configured to generate the first benchmark value 222 based on the selected portion of the rate information 248. In this manner, not all of the rate information concerning the currency pair provided by the one or more providers 208-212 during time period X needs to be considered by the benchmark value generating module 204 in order to generate the first benchmark value 222.

In one embodiment, the selection and filtering module 206 is configured to select the portion of the rate information 216 and generate the selected portion of the rate information 248 based on profile information 244, 246 associated with each of the one or more providers 208-212. As such, the selection and filtering module 206 is configured to obtain the profile information 244, 246 from the provider profile database 242 prior to performing the selection functionality. While the provider profile database 242 is illustrated in FIG. 2 as part of the apparatus 200, those having ordinary skill in the art will recognize that the provider profile database 242 could also exist remotely from the apparatus 200, and could be operatively connected to the apparatus through one or more wired or wireless networks.

Nonetheless, in one embodiment, the profile information may include provider-type information 244 and/or historical performance information 246. The provider-type information 244 identifies each particular provider (e.g., each of providers 208-212) as one of a bank, an electronic communications network (ECN), or a non-bank. The historical performance information 246 describes the past performance of each particular provider (e.g., each of providers 208-212) in terms of volumes traded and/or acceptance ratio. As known in the art, volume traded refers to the volume transacted over a period of time. Similarly, as known in the art, acceptance ratio is the inverse of a rejection ratio, where a rejection ration refers to how often a given provider has retracted its published rate. Stated differently, acceptance ratio is equal to the volume traded divided by the volume requested, over the same period of time.

In one embodiment, the selection and filtering module 206 is also configured to filter the rate information 216 and/or the rate information 218 prior to the benchmark value generating module generating benchmark values 222, 224. Filtering may be performed in a variety of ways. For purposes of simplicity, the following discussion regarding filtering will refer only to rate information 216, however, those having ordinary skill will appreciate that the following filtering techniques may be equally applied to rate information 218.

In one example, filtering involves eliminating a highest rate and a lowest rate from the rate information 216 prior to generating the first benchmark value 222. Performing this type of filtering may have the effect of eliminating statistical anomalies from the rate information that is ultimately relied on to generate the first benchmark value 222 (i.e., the selected portion of the rate information 248, in this embodiment).

In another example, filtering involves eliminating at least one stale rate from the rate information 216 prior to generating the first benchmark value 222. As known in the art, a stale rate refers to a rate that has not been updated. For example, market participants (e.g., users) expect liquidity providers (e.g., providers 208-212) to keep their rates updated with a certain amount of frequency. Accordingly, the instant apparatus 200 may include logic configured to analyze a given rate from a provider (e.g., provider 208) and determine whether the rate under consideration is stale. Such “stale” rates may then be excluded (e.g., “filtered out”) from the rates used to generate the benchmark value(s) 222/224.

In still another example, filtering involves eliminating at least one inverted rate from the rate information 216 prior to generating the first benchmark value 222. For example, in general, the bid rate for X amount of a currency pair is less than the offer rate for X of the same currency. An inverted rate exists when the bid is more than the offer. This is unusual, and not generally expected by market participants. Thus, in one embodiment, the selection and filtering module 206 of the apparatus 200 is configured to filter inverted rates out from the rates that are considered for purposes of generating the benchmark value(s) 222/224.

As noted above, in one embodiment, apparatus 200 includes a transactional cost analysis module 226 operatively connected to the benchmark value generating module 204. In this embodiment, the transactional cost analysis module 226 is configured to obtain one or more benchmark values (e.g., benchmark value 222) from the benchmark value generating module 204 and generate transactional cost analysis information 228 on a per-user basis based on the obtained one or more benchmark values. Transaction costs analysis measures the cost-efficiency of a specific transaction. While there are several, known interpretations as to what constitutes cost-efficiency, in general, market participants agree that one basic measure involves comparing the specific rate at which a transaction was consummated versus the prevailing rate in the market.

In still another embodiment, the benchmark value generating module 204 is further configured to transmit the first and/or second benchmark values 222, 224 to an auditor 250 for auditing. As known in the art, it may be necessary for one or more auditors to vet the accuracy of the generated benchmark values (e.g., generated benchmark values 222, 224). As used herein, an “auditor” may be, for example, a 3rd party external auditor capable of objectively certifying the generated benchmark value(s) 222/224. In this embodiment, the benchmark value generating module 204 is configured to transmit the first and/or second benchmark values 222, 224 to the auditor 250 over one or more wired or wireless networks using techniques well known in the art.

Referring now to FIG. 3, a flowchart illustrating a method for generating benchmark values associated with a currency pair in accordance with one example the disclosed technology is provided. Those having ordinary skill in the art will appreciate that the method illustrated in FIG. 3 may be carried out by the computing device 100 of FIG. 1, the apparatus 200 of FIG. 2, or any other suitable processing device in line with the foregoing disclosure. At step 300, a first plurality of rates associated with a currency pair are obtained from a plurality of providers during a first period of time. At step 302, a first benchmark value associated with the currency pair is generated for a first point in time based on the first plurality of rates. At step 304, a second plurality of rates associated with the currency pair are obtained from the plurality of providers during a second period of time. Finally, at step 306, a second benchmark value associated with the currency pair is generated for a second point in time based on the second plurality of rates. In one embodiment, the first plurality of rates and the second plurality of rates are obtained from the same providers. In another embodiment, the first plurality of rates and the second plurality of rates are obtained from different providers. In yet another embodiment, the first plurality of rates and the second plurality of rates are obtained from some, but not all, of the same providers.

Referring now to FIG. 4, a flowchart illustrating another method for generating benchmark values associated with a currency pair in accordance with one example the disclosed technology is provided. Steps 300 and 304 of FIG. 4 are carried out in accordance with the discussion of those steps set forth above with regard to FIG. 3. Beginning at step 400, a portion of the first plurality of rates associated with the currency pair is selected. At step 402, a first benchmark value associated with the currency pair for a first point in time is generated. The first benchmark value is generated based on the selected portion of the first plurality of rates. At step 406, a portion of the second plurality of rates associated with the currency pair is selected. Finally, at step 408, a second benchmark value associated with the currency pair for a second point in time is generated.

Referring now to FIG. 5, a flowchart illustrating yet another method for generating benchmark values associated with a currency pair in accordance with one example the disclosed technology is provided. Steps 300-306 of FIG. 5 are carried out in accordance with the discussion of those steps set forth above with regard to FIG. 3. Beginning at step 500, display data is generated representing the first and second benchmark values. This display data is configured for display on a display device.

Referring now to FIG. 6, a flowchart illustrating another method for generating benchmark values associated with a currency pair in accordance with one example the disclosed technology is provided. Steps 300-306 of FIG. 6 are carried out in accordance with the discussion of those steps set forth above with regard to FIG. 3. Beginning at step 600, a transactional cost analysis is generated on a per-user basis. The transactional cost analysis is generated based on at least one of the first and second benchmark values.

Referring now to FIG. 7, a flowchart illustrating another method for generating benchmark values associated with a currency pair in accordance with one example the disclosed technology is provided. Steps 300-306 of FIG. 7 are carried out in accordance with the discussion of those steps set forth above with regard to FIG. 3. Beginning at step 700, at least one of the first and second benchmark values are transmitted to an auditor for auditing.

### Exemplary System Features and Constraints

The following represents exemplary features and constraints of one or more embodiments of the instant disclosure. These features and constraints are not intended to limit the disclosure in any way, but rather, are intended to provide details regarding one or more exemplary embodiments.

### Objective

Utilize Applicant's immense amount of rates data from various liquidity providers to create benchmark rates for all available currency pairs. The benchmark value(s) allow customers to do transaction cost analyses, evaluate the quality of rates by their providers, and/or make trading decisions based upon the benchmark value(s).

### Exemplary Criteria

The benchmark rates should be a set of rates calculated objectively by a third party and audited by a reputable firm periodically. The rates should be a representative of the overall market and one should expect that rate to be an executable rate at the given time. The frequency of the benchmark should be published near real time, with a benchmark rate per currency per second.

### Exemplary Procedure

Identify top ten banks and top five ECN's which regularly provide tight feeds. Of course, the number of banks and ECN's identified may be modified as desired without departing from the scope of the instant disclosure, as will be appreciated by those having ordinary skill in the art.

Observe the rates 500 milliseconds before the second (i.e., the “first point in time” and/or the “second point in time”) and 500 milliseconds after the second. Of course, those having ordinary skill in the art will recognize that the first point in time need not be situated at the midpoint of the first period of time. For example, in one embodiment, the first point in time may occur at or around the end of the first period of time. In still another embodiment, the first period of time and the first point in time may be the same. Stated another way, in this embodiment, a “snapshot” of one or more rates associated with a currency pair is taken at a given point in time, rather than over a period of time.

In one example, ensure there are at least 15 data points for a given second or don't publish a benchmark for that second. In another example, the benchmark value from the previous second may be repeated, with the understanding that if no providers (among the selected providers) have updated their rates, then the prevailing rates from the previous second should not be considered stale.

Calculate the mid rate from each of the rates.

Assign different weights to rates that were 1) quoted and not hit against; 2) hit but rejected by liquidity provide (LP); 3) hit and traded against (e.g., a rate that was traded against will get twice the weight as the one quoted and not hit against, and the rate that was quoted and not hit against will get twice the weight of a rate that was hit but rejected). Of course, the preceding weighting scheme reflects but one example of the manner in which rates may be weighted. The actual weighting scheme may be modified from the above example as desired without departing from the teachings of the instant disclosure. The rate from rejected quotes should still be considered because the quote can be rejected not only due to rate movement, but many other factors as well.

Assign different weights to rates depending on the time. The rates closer to the second should get more weight (for example, a rate at 2:16:01:100 should get a higher weight than a rate at 2:16:01:400 for the benchmark calculated for 2:16:01). The preceding weighting scheme would typically be applied in a scenario in which rates are sampled approximately 500 ms before and 500 ms after the point in time for which a benchmark value is sought. In another example, only rates that are published before the point in time for which a benchmark value is sought may be considered. In this example, rates that are further away from the point in time may receive a lower weight than rates that are closer to the point in time.

Calculate a weighted average mid rate based on the weights above.

Identify appropriate spreads for different trade sizes.

Publish rates on a widget in FXI and on a webpage accessible via a network (e.g., the Internet). In still another example, rates may be distributed directly to users using communication techniques known in the art. In still another example, a report may be generated and communicated to users, wherein the report includes all of the pertinent information (including, but not limited to, any generated benchmark values) necessary for users to perform their own analyses.

### Examples of Assigning Time-Based Weights

Distance=Distance from quote to the exact second=If(ms>500,ms−1000,ms)

Weight=weight of the quote=1−abs(distance/500)

Weight at exactly the second is 1, the farther away the quote is from the second, the lower the weighting. Of course, the preceding technique for applying weights is merely exemplary in nature and reflects a scenario in which rates that are published both before and after the point in time for which a benchmark value is sought are considered. As noted above, in another embodiment, only rates that are published before the point in time for which a benchmark value is sought may be considered. In such an embodiment, rates that are published closer in time to the point in time for which a benchmark value is sought may be given a greater weight than rates that are published further away in time to the point in time for which the benchmark value is sought. In still another embodiment, only rates that are published after the point in time may be considered for purposes of generating a benchmark value. In such an embodiment, rates that are published closer in time to the point in time for which a benchmark value is sought may be given a greater weight than rates that are published further away in time to the point in time for which the benchmark value is sought.

### Additional Exemplary Features

Furthermore, while the above description has generally discussed providing different benchmark values at different times, one exemplary aspect of the present disclosure involves generating different types of benchmark values, at either the same time or different times. For example, in one embodiment, two separate types of benchmark values could be generated: (a) a first benchmark value for mid rate and (b) a second, different, benchmark value for rate at size.

Further still, exemplary embodiments of the present disclosure provide for the ability to dynamically select different providers based upon particular criteria at different time periods. For example, the providers providing the rates in one month could differ from the providers providing the rates in a different month (or any other unit of time, months being but one example). Accordingly, one sub-set of all of the providers may be selected for use in benchmark value generation for a particular period of time, while a different sub-set of providers may be used for benchmark value generation for a different period of time.

### CONCLUSION

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method, the method comprising:
obtaining, by a processor, a first plurality of rates associated with a currency pair from a plurality of providers during a first period of time;
generating, by the processor, a first benchmark value associated with the currency pair for a first point in time based on the first plurality of rates;
obtaining, by the processor, a second plurality of rates associated with the currency pair from the plurality of providers during a second period of time; and
generating, by the processor, a second benchmark value associated with the currency pair for a second point in time based on the second plurality of rates.

2. The computer-implemented method of claim 1, further comprising:
selecting a portion of the first plurality of rates associated with the currency pair; and
wherein generating the first benchmark value is based on the selected portion of the first plurality of rates.

3. The computer-implemented method of claim 2, wherein selecting the portion of the first plurality of rates associated with the currency pair is based on profile information associated with each of the plurality of providers.

4. The computer-implemented method of claim 3, wherein the profile information associated with each of the plurality of providers comprises:
provider type information identifying each particular provider as one of a bank, an electronic communications network (ECN), or a non-bank; and
historical performance information describing a past performance of each particular provider in terms of at least one of: volume traded and acceptance ratio.

5. The computer-implemented method of claim 1, wherein generating the first benchmark value associated with the currency pair based on the first plurality of rates comprises at least one of:
determining an average rate of the first plurality of rates for the first period of time;
determining a median rate of the first plurality of rates for the first period of time; and
determining an optimal rate of the first plurality of rates for the first period of time.

6. The computer-implemented method of claim 1, wherein generating the first benchmark value associated with the currency pair based on the first plurality of rates comprises at least one of:
determining price at depth;
determining a first volume-weighted average price (VWAP) for the first plurality of rates;
determining a second VWAP for the first plurality of rates, wherein the second VWAP is based on an approximated predefined rejection rate;
determining an average of the first VWAP and the price at depth;
determining a time-weighted average price (TWAP) using a weighted average price over a moving predetermined window of time; and
determining a best bid and a best offer at each size for the first plurality of rates based upon block trade rates obtained from one or more of the plurality of providers.

7. The computer-implemented method of claim 1, further comprising:
filtering at least one of the first and second plurality of rates prior to generating at least one of the first and second benchmark values.

8. The computer-implemented method of claim 7, wherein filtering at least one of the first and second plurality of rates comprises at least one of:
eliminating a highest rate of the first plurality of rates and a lowest rate of the first plurality of rates prior to generating the first benchmark value;
eliminating at least one stale rate of the first plurality of rates prior to generating the first benchmark value; and
eliminating at least one inverted rate of the first plurality of rates prior to generating the first benchmark value.

9. The computer-implemented method of claim 1, further comprising:
generating display data representing the first benchmark value for display on a display device; and
generating display data representing the second benchmark value for display on the display device.

10. The computer-implemented method of claim 1, further comprising:
generating a transactional cost analysis on a per-user basis based on at least one of the first and second benchmark values.

11. The computer-implemented method of claim 1, further comprising:
transmitting at least one of the first and second benchmark values to an auditor for auditing.

12. The computer-implemented method of claim 1, wherein the first period of time comprises a period of time extending from approximately 500 milliseconds before the first point in time to approximately 500 milliseconds after the first point in time.

13. An apparatus comprising:
a rate obtaining module configured to: (i) obtain a first plurality of rates associated with a currency pair from a plurality of providers during a first period of time and (ii) obtain a second plurality of rates associated with the currency pair from the plurality of providers during a second period of time; and
a benchmark value generating module operatively connected to the rate obtaining module, the benchmark value generating module configured to: (i) generate a first benchmark value associated with the currency pair for a first point in time based on the first plurality of rates and (ii) generate a second benchmark value associated with the currency pair for a second point in time based on the second plurality of rates.

14. The apparatus of claim 13, further comprising:
a selection and filtering module operatively connected to the rate obtaining module and the benchmark value generating module, the selection and filtering module configured to select a portion of the first plurality of rates associated with the currency pair, and wherein the benchmark value generating module is configured to generate the first benchmark value based on the selected portion of the first plurality of rates.

15. The apparatus of claim 14, wherein the selection and filtering module is configured to select the portion of the first plurality of rates based on profile information associated with each of the plurality of providers.

16. The apparatus of claim 15, wherein the profile information associated with each of the plurality of providers comprises:
provider type information identifying each particular provider as one of a bank, an electronic communications network (ECN), or a non-bank; and
historical performance information describing a past performance of each particular provider in terms of at least one of: volume traded and acceptance ratio.

17. The apparatus of claim 13, wherein the benchmark value generating module is configured to generate the first benchmark value associated with the currency pair based on the first plurality of rates by performing at least one of the following operations:
determining an average rate of the first plurality of rates for the first period of time;
determining a median rate of the first plurality of rates for the first period of time; and
determining an optimal rate of the first plurality of rates for the first period of time.

18. The apparatus of claim 13, wherein the benchmark value generating module is configured to generate the first benchmark value associated with the currency pair based on the first plurality of rates by performing at least one of the following operations:
determining price at depth;
determining a first volume-weighted average price (VWAP) for the first plurality of rates;
determining a second VWAP for the first plurality of rates, wherein the second VWAP is based on an approximated predefined rejection rate;
determining an average of the first VWAP and the price at depth;
determining a time-weighted average price (TWAP) using a weighted average price over a moving predetermined window of time; and
determining a best bid and a best offer at each size for the first plurality of rates based upon block trade rates obtained from one or more of the plurality of providers.

19. The apparatus of claim 13, further comprising:
a selection and filtering module operatively connected to the rate obtaining module and the benchmark value generating module, the selection and filtering module configured to filter at least one of the first and second plurality of rates prior to generating at least one of the first and second benchmark values.

20. The apparatus of claim 19, wherein the selection and filtering module is configured to filter at least one of the first and second plurality of rates by performing at least one of the following operations:
eliminating a highest rate of the first plurality of rates and a lowest rate of the first plurality of rates prior to generating the first benchmark value;
eliminating at least one stale rate of the first plurality of rates prior to generating the first benchmark value; and
eliminating at least one inverted rate of the first plurality of rates prior to generating the first benchmark value.

21. The apparatus of claim 13, wherein the benchmark value generating module is further configured to:
generate display data representing the first benchmark value for display on a display device; and
generate display data representing the second benchmark value for display on the display device.

22. The apparatus of claim 13, further comprising:
a transaction cost analysis module operatively connected to the benchmark value generating module, the transaction cost analysis module configured to generate a transactional cost analysis on a per-user basis based on at least one of the first and second benchmark values.

23. The apparatus of claim 13, wherein the benchmark value generating module is further configured to:
transmit at least one of the first and second benchmark values to an auditor for auditing.

24. A non-transitory computer-readable medium comprising executable instructions that when executed by a processor cause the processor to carry out a method comprising:
obtaining a first plurality of rates associated with a currency pair from a plurality of providers during a first period of time;
generating a first benchmark value associated with the currency pair for a first point in time based on the first plurality of rates;
obtaining a second plurality of rates associated with the currency pair from the plurality of providers during a second period of time; and
generating a second benchmark value associated with the currency pair for a second point in time based on the second plurality of rates.
